(19) United States
(12) Patent Application Publication
(10) Pub. No.: US 2018/0197206 A1
(43) Pub. Date: Jul. 12, 2018

(54) Real-time Mobile Multi-Media Content Management System for marketing, Communication and Engagement

(71) Applicant: Ava Herrera, South Pasadena, CA (US)

(72) Inventor: Ava Herrera, South Pasadena, CA (US)

(73) Assignee: Ivory Clay, South Pasadena, CA (US)

(21) Appl. No.: 15/917,823

(22) Filed: Mar. 11, 2018

Related U.S. Application Data
(63) Continuation of application No. 14/475,049, filed on Sep. 2, 2014, now abandoned.
(60) Provisional application No. 61/872,825, filed on Sep. 2, 2013.

(51) Int. Cl. G06Q 30/02; H04L 29/08; G06Q 50/00

(52) U.S. Cl. CPC G06Q 30/0267; H04L 67/22; G06Q 50/01; G06Q 30/0246; G06Q 30/0269; H04L 67/20

(57) ABSTRACT

A real-time mobile multi-media content management and communications system for marketing and engagement. The system comprises a processor, a storage and instructions for a multi-media user interface module, a multi-media content collection module, and a multi-media templating module, a communications module, where the modules provide a user with real-time multi-media content management to market and engage third parties.

### CROSS-REFERENCE TO RELATED APPLICATIONS

This application is a continuation of U.S. patent application Ser. No. 14/475,049, filed on 2014 Sep. 2, which claims the benefit under 35 U.S.C. § 119(e) of U.S. Provisional Patent Application Ser. No. 61/872,825 2013 Sep. 2, filed on 2013 Sep. 2, the contents of both applications are incorporated herein by reference in their entirety.

### FIELD OF THE INVENTION

The present invention is directed to marketing and more specifically to a system for a real-time mobile multi-media content management system for marketing, communication and engagement.

### BACKGROUND

There is no mobile solution that allows all types of content (photos, text, audio clips, video clips, calls to action, website links) to be gathered and formatted quickly and easily onto a page for sharing while on-the-go. With our core technology (Hub36 and DotGlu) users have the ability to create comprehensive messaging right from their mobile device without the delay of having to get to a desktop or the hassle of trying to format messages on social media platforms or in photo sharing products.

Millions of smartphones are in use worldwide. Billions of photos and videos are uploaded to social media each year. Brands are looking for ways to engage with customers through social media channels, in essence-companies want to and should go where their customers are.

There are desktop software tools like Constant Contact® and Mail Chimp® that allow a user to use a template to format data and send it to an email distribution list with links to Facebook® and Twitter® feeds. These are not a mobile or real-time solutions, nor are they particularly fast to create a campaign: on the contrary, there is a steep learning curve, and inputting data and laying out a page can take hours if not days depending on ability.

There are also scrapbooking systems, such as, Coolibah and TapNScrap. These systems mainly use Drag n Drop technology, are cumbersome, unstable and do not allow the user to move swiftly in creating a page. Additionally, companies like Shutterfly and Snapfish have desktop software to create scrapbook or photobooks, but are not mobile solutions to making a page.

Therefore, there is a need for a real-time mobile multi-media content management system for marketing, communication and engagement that solves the problems in the related art.

### BRIEF DESCRIPTION OF THE DRAWINGS

These and other features, aspects and advantages of the present invention will become better understood with regard to the following description, appended claims, and accompanying figures where:

FIG. 1 is a flowchart diagram of a system for a real-time mobile multi-media content management system for marketing, communication and engagement according to one embodiment;

FIG. 2 is a dialog box diagram of an implementation of the system of FIG. 1 showing a role selection dialog;

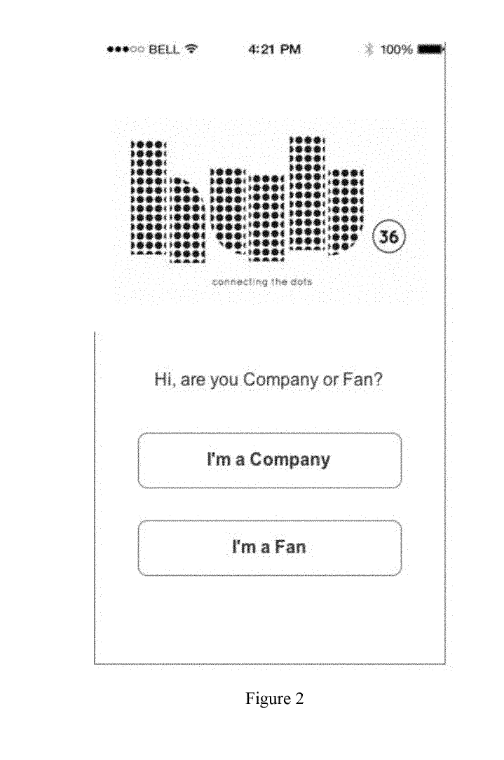

FIG. 3 is a dialog box diagram of an implementation of the system of FIG. 1 showing a login dialog;

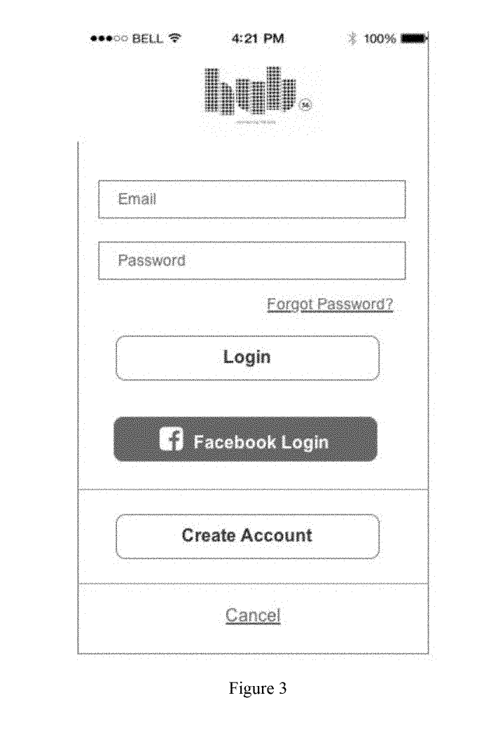

FIG. 4 is a dialog box diagram of an implementation of the system of FIG. 1 showing an account creation dialog;

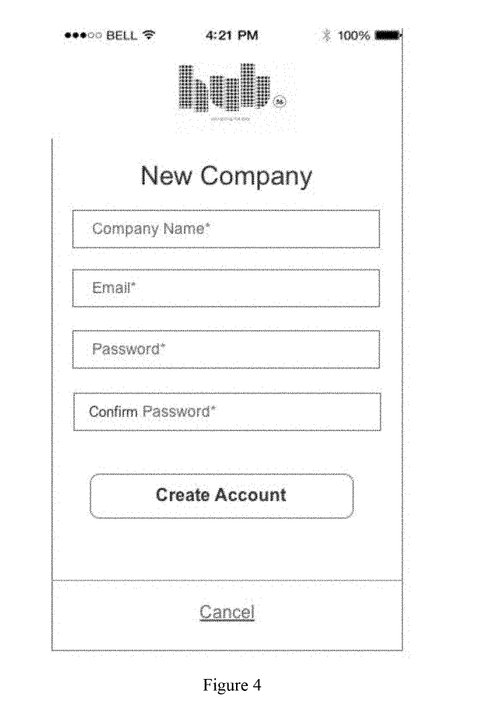

FIG. 5 is a dialog box diagram of an implementation of the system of FIG. 1 showing a template selection dialog;

FIG. 6 is a dialog box diagram of an implementation of the system of FIG. 1 showing a filter selection dialog;

FIG. 7 is a dialog box diagram of an implementation of the system of FIG. 1 showing an add page content dialog;

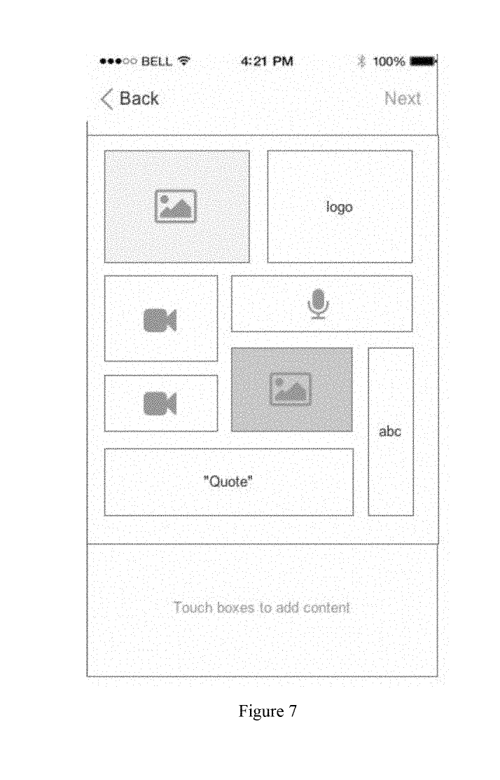

FIG. 8 is a dialog box diagram of an implementation of the system of FIG. 1 showing an add textual content dialog;

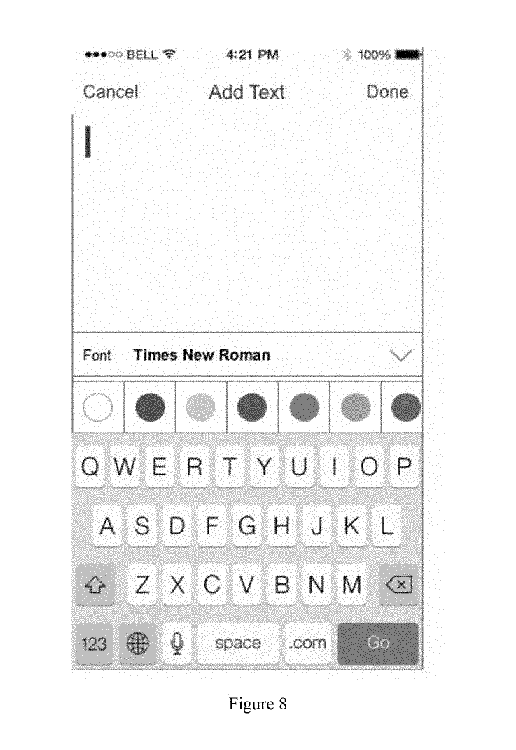

FIG. 9 is a dialog box diagram of an implementation of the system of FIG. 1 showing an image editing dialog;

FIG. 10 is a dialog box diagram of an implementation of the system of FIG. 1 showing an add comment to page dialog;

FIG. 11 is a dialog box diagram of an implementation of the system of FIG. 1 showing an add image to page dialog;

FIG. 12 is a dialog box diagram of an implementation of the system of FIG. 1 showing an add video to page dialog;

FIG. 13 is a dialog box diagram of an implementation of the system of FIG. 1 showing an add audio to page dialog;

FIG. 14 is a dialog box diagram of an implementation of the system of FIG. 1 showing a page preview dialog;

FIG. 15 is a dialog box diagram of an implementation of the system of FIG. 1 showing a share page dialog;

FIG. 16 is a dialog box diagram of an implementation of the system of FIG. 1 showing a sharing confirmation dialog; and

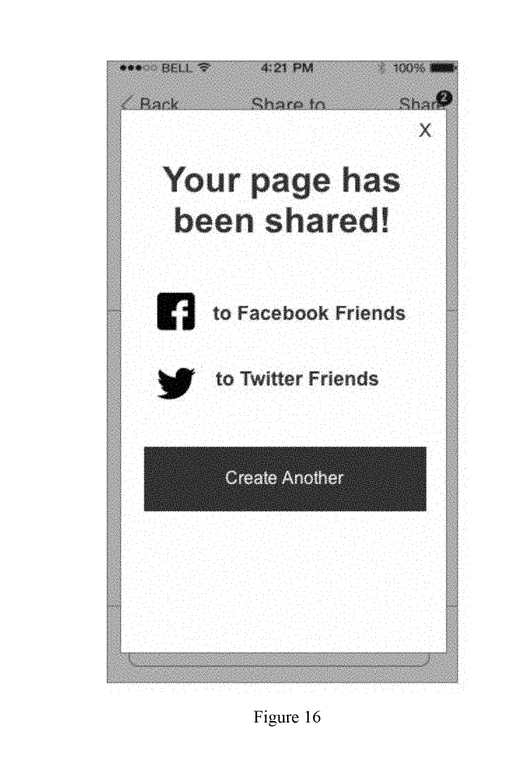

FIG. 17 is a wireframe flowchart diagram of some steps of a method for using the system of FIG. 1.

### SUMMARY

The invention overcomes the limitations of the prior art by providing a system that can be used in both consumer and business marketing. Generally, the system is most likely to be used by Generation X (Gen X) users, born 1965-1979, ages 35-49, and Generation Y or Millennials (Gen Y) users, born 1980-2000, ages 18-34) and those businesses and individuals engaging with them. However, this is only exemplary and not meant to be limiting.

There are currently 50 million Gen X and 70 million Gen Y users today. Both groups of users understand technology and rely on it daily. They are also comfortable with learning new skills, and are looking for ways to complete any task faster. In addition, both groups value real-time capabilities and instant feedback.

The invention is directed to the more than 100 million users that can use it for a personal reason, such as, for example, scrap booking, saving events with friends, or for business reasons such as reciprocal engagement of customers with brands they are familiar with.

Both groups understand that mobile, social media, real-time, speed and instant feedback are critical to completing their job so they can: a) move to the next task, and b) finish a task and get back to their life.

The present invention is a fast, real-time solution for creating and formatting content “on-the-go.” Users create memory or scrapbook type pages to share with family, while businesses generate content-rich, branded pages to promote products, announce events and engage customers easily and quickly. Users can quickly interact with social media, share their experience in real-time and drive engagement to users' circles of friends. Business users can mine valuable marketing information with built-in backend analytics tracking each click.

The system is a real-time mobile multi-media content management and communications system for marketing and engagement. The system comprises a processor comprising a storage where the storage contains instructions executable on the processor. The instructions for the system have a multi-media user interface module, a multi-media content collection module, a multi-media templating module, and a communications module. The modules provide a user with real-time multi-media content management to market and engage third parties.

The multi-media user interface module comprises instructions to display a simple interface to the user to gather multi-media content from various content storages. The multi-media user interface module also displays easy to identify icons to indicate the kind or type of content that would be gathered by the user and provides instructions to the user on how to operate the system.

The multi-media content collection module comprises instructions to capture, organize and format multi-media content from multiple mobile software applications across multiple platforms. The system comprises one or more than one algorithm to automatically identify the content, resize, reformat and otherwise adjust the content for use in the system. The system builds multi-media content in real time, so that the user can quickly review, approve and edit the content as the system adds more content. Also, the user can collect the multi-media content and build a marketing page on one screen without using any external programs by selecting content from the group consisting of photos, text, details, quotes, places, dates, titles, audio or video or any other form of multi-media content either known or contemplated in the future. The multi-media content is dynamically loaded, and the type of content is also automatically identified and inserted, into a user selected template after the system automatically collects and resize/reformats the content to fit the appropriate container in the template. Each template container comprises instructions that can automatically resize/reformat the content without user intervention.

The multi-media templating module can display one or more than one pre-designed template to automate placement of multimedia content objects. The user can create a composite page of audio, video, text, image and location data that can be shared with other users. User can select a pre-designed template consisting of a memory page, a scrapbook page, a content-rich branded page to promote products, or an event announcement page. Additionally, the user can create their own template using the system by dragging and dropping elements to a blank template either using a mobile device or on a computer with a stand alone program or a web-based interface. The pre-designed template comprises instructions to populate the selected placeholder with multi-media content. The system also has a credential module for accessing private templates that are not available to the public.

The multi-media content collection module can arrange the multi-media content on the user selected template in a pre-determined arrangement based on the pre-designed template design. The system dynamically adjusts and reformats the finished page based on the size and type of the collected multi-media content. The user can review the multi-media content in a plurality of templates simply by selecting a different template. If the selected template does not have containers or placeholders for the selected content, new multi-media content can be automatically added or the user can select a specific item to place in the new template. However, if the user declines to use all the available multi-media content options on the pre-designed template, the system automatically removes any supporting graphics from the finished page related to declined multi-media content.

The communication module comprises instructions executable on the processor so users can interact with social media in real-time to engage the user's friends. The finished page can be transmitted to one or more locations selected from the group consisting of Facebook®, Twitter®, Tumblr®, DropBox®, email, a text message, a camera roll, Instagram®, or Pinterest®. As will be understood by those with skill in the art with reference to this disclosure, other social media sites can also be used and the above list is an exemplar and not intended to be limiting. The communications module can also transmit the finished page to the one or more than one location as a clickable link that enacts a browser window to open and display the finished page, properly reformatted.

The system further comprises a back-end server for backend analytics that can track user interaction with the system. The back-end server has a processor and a storage for storing data and instructions executable on the processor and a data mining module to perform analytics for tracking each click that occur on pages created and published by the system. The analytics tracked by the system are selected from the group consisting of templates used, templates purchased, template style, sharing location, a number of applications used by location, or a call to action clickthru.

In addition, the system can have a secured server that can host the multi-media content and pre-designed templates to be retrieved by the mobile device in case the device does not have enough computing power to enable real-time collection and editing of the final page. The secured server can transfer the multi-media content to the finished page at each sharing location.

There is also provided a method for using the system. First the user downloads the system onto a mobile computing device. Then, the user executes the system on the computing device. Next, the system displays an option to watch a short tutorial video. Then, the user selects “new page” to collect multi-media content from the computing device, a storage or both the computing device and the storage. The user next reviews the collected multi-media content. Then, the user can edit the collected multi-media content. Next, the reviewed and edited collected multi-media content is displayed on the final page. Then, a state of the page of multi-media content collection is stored in a storage in case an event occurs to interrupt the system. Finally, the page is shared on social media channels after all the multi-media content is collected, reviewed, saved, edited, changed templates and finalized. The method further comprises saving the collected data and the page at any point in the collection process. The mutli-media content can be collected from storage locations selected from the group consisting of email, text, Dropbox®, or a camera roll among others.

### DETAILED DESCRIPTION

The present invention overcomes the limitations of the prior art by providing a real-time mobile multi-media content management system for marketing, communication and engagement. The system and methods as disclosed herein provide a multi-media content management system for marketing and engagement that provide the capability for a user to capture, organize and format multimedia content in multiple mobile software applications across multiple platforms and communicate it in virtual, real-time. The system can include pre-designed templates that automate placement of multimedia content objects, such as, for example, photographs. A user can create a composite page of audio, video, text, image and location data that can be shared with others.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

The software identified above can also be constructed in a module. A module is a logically self-contained and discrete part of a larger computer program, for example, a subroutine or a co-routine. Modules are typically incorporated into the program through interfaces. A module interface expresses the elements that are provided and required by the module. The elements defined in the interface are detectable by other modules. The implementation contains the executable code that corresponds to the elements declared in the interface. Modules perform logically discrete functions. A module can interact with other modules of the system to achieve its purpose.

Various embodiments provide for a multi-media content management and communication system for marketing and engagement. One embodiment of the present invention provides a multi-media content management system for marketing and engagement. In another embodiment, there is provided a method for using the system. The system and method will now be disclosed in detail.

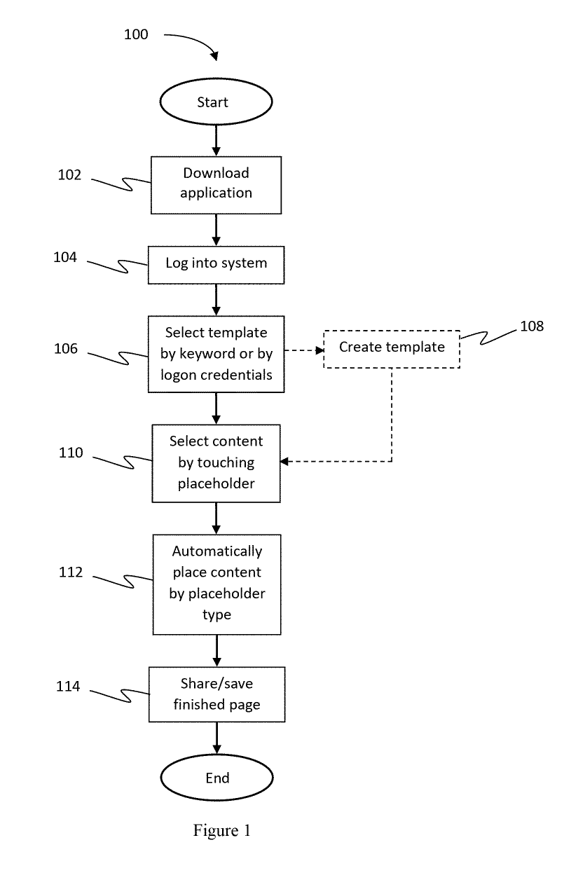

Referring now to FIG. 1, there is shown a flowchart diagram 100 of a system for a real-time mobile multi-media content management system for marketing, communication and engagement according to one embodiment. The system 100 is a fast, real-time platform for creating and formatting content on-the-go in several capacities. Users can create memory or scrapbook type pages to share with family, while businesses generate content-rich, branded pages to promote products, announce events and engage customers easily and quickly. Users can quickly interact with social media; share their experience in real-time and drive engagement to users' circles of friends. Business users can mine valuable marketing information with built-in backend analytics tracking each click.

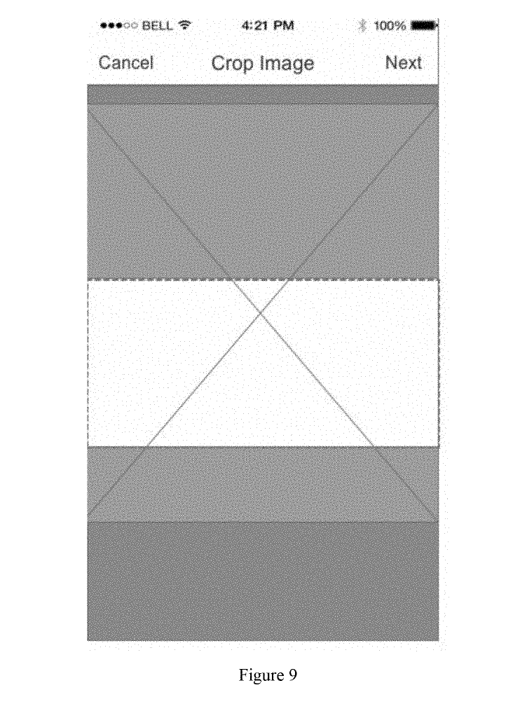

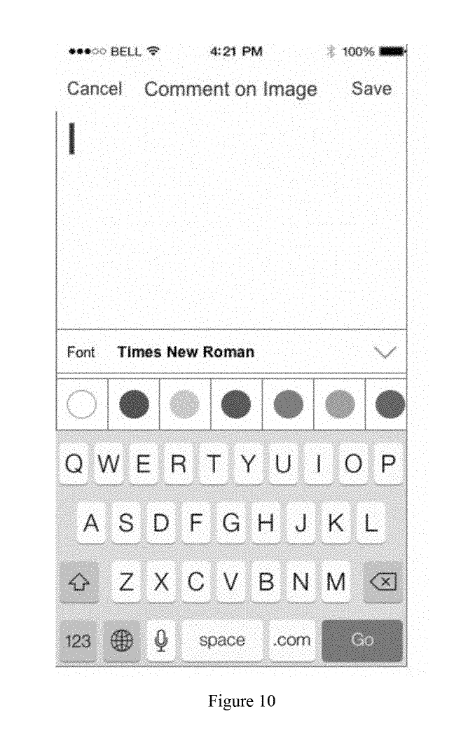

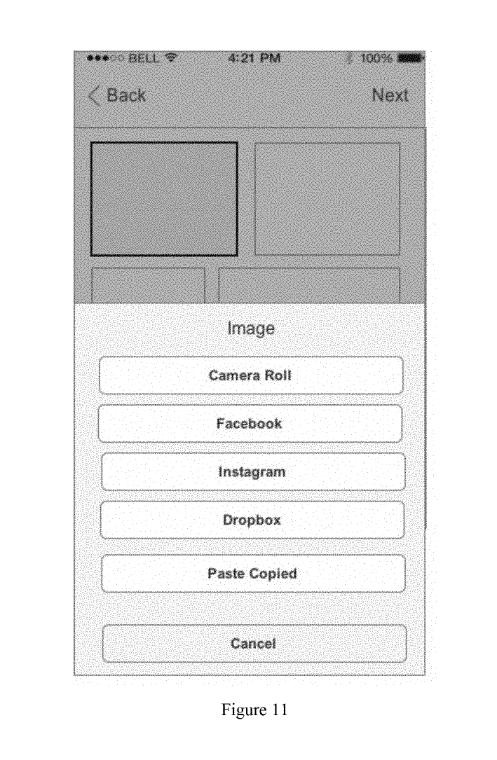

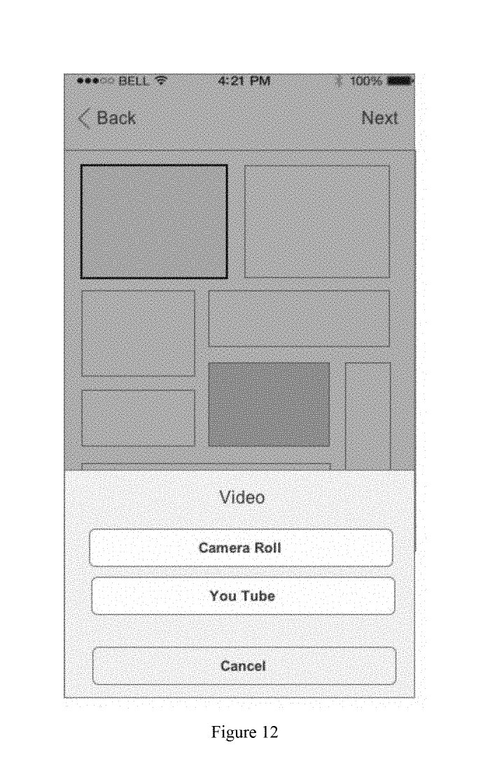

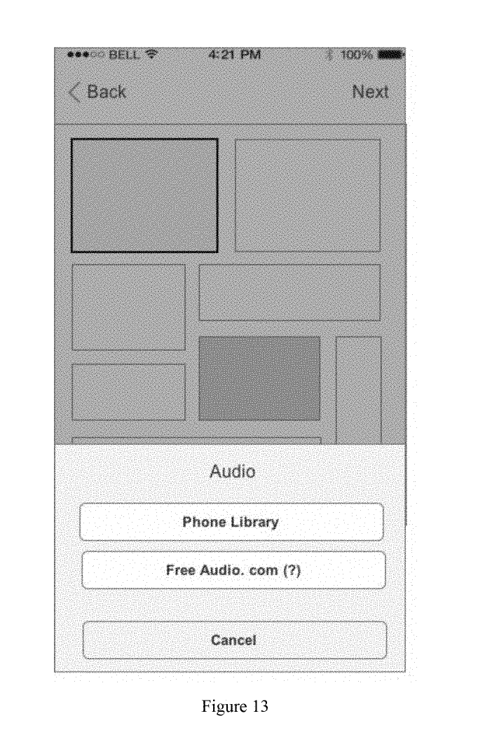

The system 100 comprises instructions operable on a processor that present the user with a simple interface to gather multi-media content as shown in the dialog box diagrams of FIGS. 9-13. The user interface comprises easy to identify icons to indicate the kind or type of content that would be gathered by the user selecting each icon. The system comprises instructions that build multi-media content in real time, so that the user can quickly review, approve and edit the content as the system adds more content. The user interface can also provide instructions to the user.

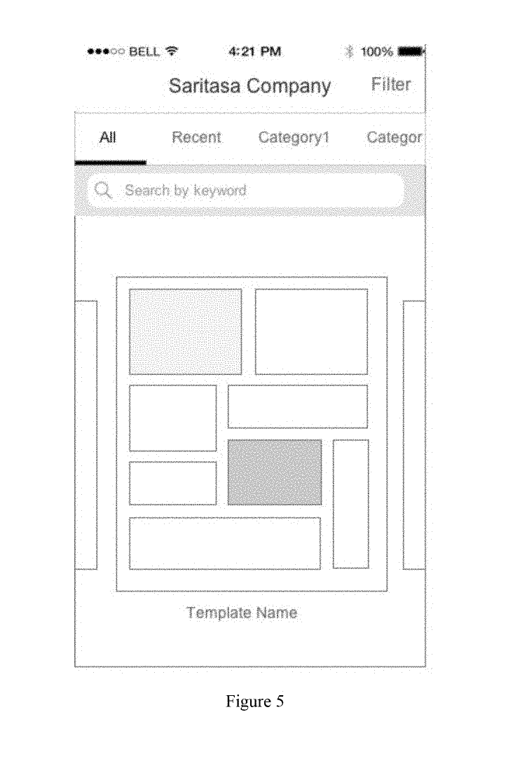

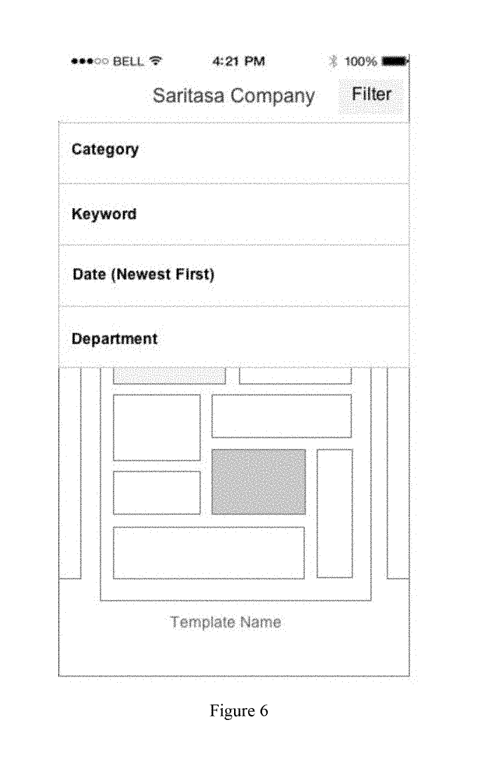

The system 100 also comprises instruction so that the user can collect the multi-media content and build it in one page or screen. That is, to begin in one place and go out to retrieve and return to one screen. The user can use filters to assign the template to different areas of the app and make it searchable as shown in FIG. 6. Optionally, the user experience can be enhanced by selecting the template first so that the user can touch placeholders on the screen to populate that placeholder with multi-media content as shown in FIG. 5. In this example, the actual finished page is built in front of the user, rather than data being collected and then selecting the template.

As used throughout this disclosure, the multi-media content can be selected from the group consisting of photos, text, details, quotes, places, dates, titles, audio, video and Call-to-Action links.

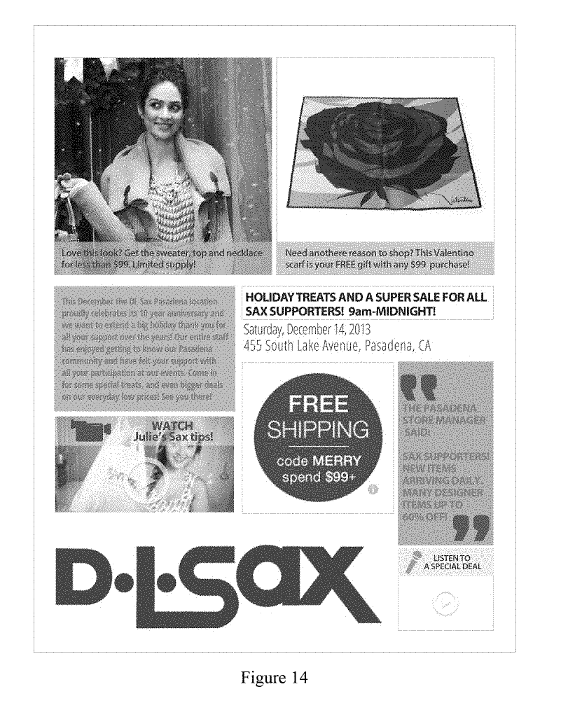

The multi-media content can be dynamically loaded into the user selected template. The system comprises instructions executable on the processor for an algorithm to automatically determine the type of the selected multi-media content 112 and can arrange the multi-media content on the user selected template in a pre-determined arrangement for that template design. If the user declines to use all the available multi-media content options, for example, the user does not include an audio clip, the system removes any supporting graphics from the finished page related to that multi-media content (i.e. the audio icon is not displayed). The system dynamically adjusts and reformats the page based on the collected multi-media content. The finished page can be reviewed and edited as can be seen in the dialog box diagram of FIG. 14. The user can also review the multi-media content in a plurality of templates prior to saving or sharing.

The system 100 can be used on-the-spot, in-the-field, as an experience is experienced by the user. All other products—like Constant Contact for example, Adobe's Creative Suite and the programs in the competitive landscape analysis—are post-event, at-the-desktop, after-the-fact, etc.

The system 100 lets the user capture an individualized experience, real-time, in a micro-communication. By amalgamating images, voice and video, it can very tightly target each communication for maximum connection between sender and recipient. Capturing this interaction, in fact the ability to make the recipient an actor in the interaction, increases the efficacy of the communication exponentially.

The system 100 also comprises back-end analytics that provide the ability for a business to secure much more individualized data, including for each micro-communication should that be used. Additionally, other demographic information can be collected and mined, this permits the data obtained from focused micro-communications to be much more precise and information rich than the gross analytics available from non-targeting communications.

Using the system 100 means that business users don't need an art department, or sophisticated marketing teams to accomplish an interaction with their customers or fans of their business. This is a fast solution for creating branded content (or content creation at your fingertips). Likewise, this is a reciprocal tool so fans can also interact with the brand, anywhere/anytime, by making pages for incentives; which not only provides brand endorsement but drives brand recognition when shared with friends.

The system 100 also comprises modules so that users can create multi-media pages that embrace several aspects of an interaction: text, photos, video, audio, web links or calls-to-action.

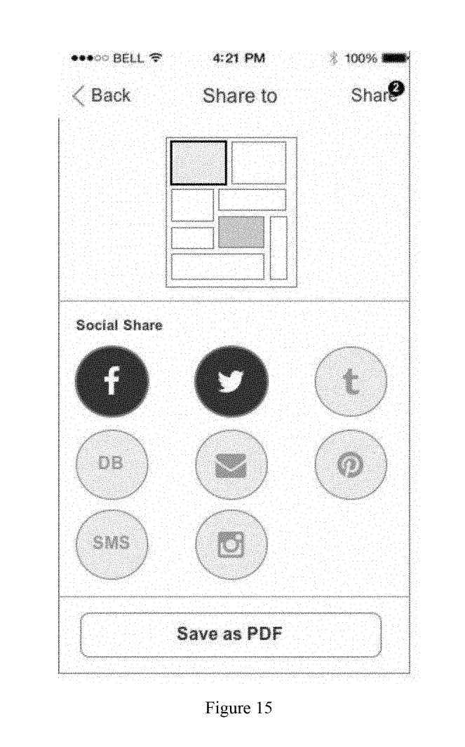

Referring now to FIG. 15 there is shown a dialog box diagram of an implementation of the system of FIG. 1 showing a share page dialog. As can be seen, the user can share the finished page on one or more locations such as, Facebook®, Twitter®, Tumblr®, DropBox®, via email, a text message, a camera roll, Instagram® and Pinterest®. Each location comprises its own criteria through a public or open API that evaluates how the finished page will ultimately be displayed on that particular sharing location. However, the finished page is received as a clickable link that enacts a browser window to open and display the finished page, properly reformatted. Audio and video clips are embedded into the finished page and can also be made available for playback through a separate pop-up dialog by clicking on each audio or video playback icon, or container displayed on the finished page.

The system also comprises instructions executable on a processor to provide backend analytics that can track user interaction with the system such as, templates used, templates purchased, the template style, the sharing location, a number of applications used by location, or a call to action clickthru.

A secured server can host the multi-media content and templates. Additionally, the secured server can transfer the multi-media content to the finished page to each sharing location.

Although the system is designed to be used on mobile devices, but other embodiments will also be available for desktop, as will be understood by those with skill in the art with reference to this disclosure. In one embodiment, the system can use standards based coding to be used on all mobile platforms that support the standards, such as, for example, Hybrid HTML5.

The pre-designed templates use containers, or placeholders, to hold the multi-media content. Each container, or placeholder holds one piece of multi-media information, such as, for example, a photo, text, an audio clip, a video clip, a web link, a QR code, header and footer information among other multi-media content.

The template, or page size is designed so that the containers are pre-determined by the template creator. The containers, or placeholders are programmatically located on the page, essentially resembling boxes, and are proportional with the finished page size. In one embodiment, the system can automatically place the multi-media content within the container that can accept that particular piece of multi-media content. This placement is static in a programmed layout, but is dynamic in regards to what multi-media content the user actually decides to include or not include in that container. Graphic elements that support a container will not show up on the finished page, if that type of content is not added and the user ‘saves’ the page. For example, if a photo container is 3″×3″, with a 0.18″ outline in red with a graphic element such as a star on one corner, that red frame and star will not show up if the user does not include a photo in that container location, and saves the page. If the user edits the page and includes a photo in that location, the red frame and star will show up around the photo as intended. Likewise, the pages can be graphically created with layers and programmed with “if then” statements to, for example, show the photo in the container as designed with the red outline and star if the user adds it, or show another graphic element, or background if the container was not used such as a larger red star. This is designed and programmed ahead of time with the forethought of what the page will look like given the options the user has to work with for that page.

Each container is coded with specific instructions for what to do with the content if, and when the user inputs it into the interface. These containers are coded to recognize if they are being used on a particular page, or not, and how to proceed given that information. The containers are coded and paths are established to recognize the content they are holding: a) where to place it on the page, b) how and if to manipulate it (resize, compress, reduce resolution) for better sharing capability, c) where and how to store it on a server, d) how to recall it, e) how to process it for saving and f) how to place each container in each page in each share location (social media, mail, text, Dropbox, camera roll) when utilizing the open APIs.

The container locations on the page are pre-determined prior to programming. As the user adds content it shows up in its location on the page, in the proper dimension for that particular page.

The software will manipulate content as necessary to work for any given template layout. High-resolution photos will be reduced in size when placed in digital versions of the page, but a copy of the hi-res version will be retained and placed on the server replacing the low-resolution image if the page will be sent to print. Audio and video files will be compressed to reduce file size for sharing. Depending on the platform that created the audio or video file, the app may convert the file from the native for better sharing through different APIs.

A finished page is stored on the device until it is shared, at which time all content is uploaded to a server.

Once shared, the page and all content is stored on the server and paths are established to recall that page, to re populate its associated content and to create a link to view the page in each shared location.

Once a page is saved, the application places the finished page file, template and content together, in a specific section within the software.

The container sizes and placements on a page are somewhat pre-determined, but the application software will be programmed to recognize and make adjustments if a particular API does not support a particular container. For Example, Dropbox does not support embedded audio and video clips in the page. In this case the app will allow the page to be shared to Dropbox but will either omit the unsupported container (audio) as if it was never added, or programmatically adjust by replacing the container (video) with a QR code linked to the video on the server. The specific action depends on the API of the share location and its capability.

The system uses a simple interface that provides users the capability to interact with each other. Each user must login to the system, establishing who the user is and what aspects of the software will be made available based on the credentials.

The system uses a set of identifying criteria to establish the available functions the user can access and how to display the multi-media user interface. System administrators can assign roles to their users. Alternatively, templates within the system can be identified as public or private or both. Administrators can also manage what containers within any given template are static (i.e logo, header, footer) and which aspects are changeable (i.e. photos, text).

Users can select from pre-designed templates or upload a custom template to the system. The template can be branded for a business and can have the containers placed in the desired locations on the page so that those containers always appear. Users can have access to detailed analytics, depending on the user's access level, within the system for the created page. This provides analytics that can monitor the traction of a page in its shared location. Users can also develop a page with a ‘daily deal’ displayed in a gallery; which offers fans the opportunity to check the software application every day for a deal and act within the 24 hour expiration period.

Several consumer and business uses for the system are contemplated. However, as will be understood by those with skill in the art with reference to this disclosure, other possible system uses can be made.

Case Study: Consumer:

A mom at a soccer game takes photos of kids playing, records a video, records an audio clip at the water break and writes detailed text explanation about the game, location, captures a funny quote and even gives the event a title. The mom is also able to add people to the system, such as, a photo, a name and an age, from a directory to include them in the finished page. The mom can then select from the available templates and page backgrounds for the event, for example a sports-themed template related to soccer. The mom shares this page to her Facebook® page so friends and family can see all the multi-media content gathered by the system of her kids playing soccer. All done real-time, without formatting hassles.

Case Study: Business-in-House:

A Century 21 real estate agent gets a new home listing. The real estate agent takes a few photos, a video tour of the grounds, records a personal note to a client and writes some text about the property. Using the system, the real estate agent emails the finished and branded page to three potential buyers that may like the house before even leaving the property.

Case Study: Business-in-House:

B.Luu a local clothing boutique announces the arrival of a new line of clothing for summer. A store manager creates a branded page using the system with the desired multi-media content and emails it to the finished page to a distribution list and also sends a text message to her top 10 clients. In this case, the finished page also comprises an embedded Call-to-Action and a 20% off coupon.

Case Study: Business to Consumer:

Midnight Run, a local band asks fans to use their branded template found in the system to create a finished page about their favorite song by the band and post it to the band's Facebook® page for a chance to win free tickets to a concert. Fans can use the system to participate in the contest and provide valuable marketing data to the band.

Business to Business: White Label Solution

The system also comprises a white label solution that is available on the system for bigger brands that do not want their templates co-mingled with other brands. The system would allow companies to re-skin the system, with reasonable adjustments to the user interface and functionality provided that a license is obtained. The system functions and can be used exactly the same way, but is a private or white label solution.

Case Study: Business to Business:

For example, Nordstrom can place a branded, re-colored, re-skinned version of the system for the user to download. The system can also provide a credential based login for in-house marketing teams to be able to see private templates for events, projects, tradeshows, interaction with media etc. These templates are for in-house use only and are not available to the public. However, Nordstrom can also place several templates in the public area of the system that can be used to announce various contests, so that Nordstrom fans can interact with the brand for incentives.

Case Study: Business to Consumer/Consumer to Business:

Parents at a birthday party a a Chuck E. Cheese's are asked to download the system 100 to create pages of the party and post them to Facebook® in real-time. Parents make pages and post right from the party and are rewarded with additional game tokens and the birthday child gets a Chuck E. Cheese stuffed animal. Chuck E. Cheese's gets real-time endorsements form all the participating parents on Facebook. Similarly, the template supplied by Chuck E. Cheese's and used by the parents has embedded calls-to-action, so other people viewing the page and clicking on links in the page can also receive discounts and incentives for Chuck E. Cheese's. The reach becomes extensive for driving brand awareness and engagement.

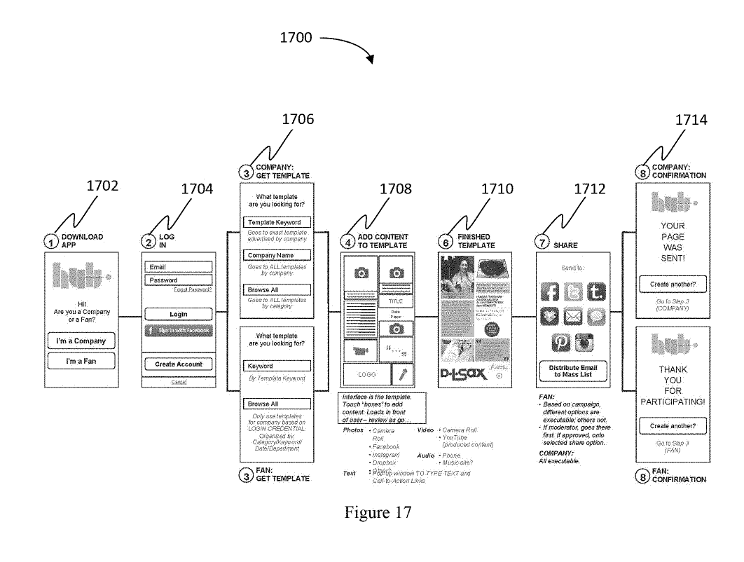

Referring now to FIG. 17, there is shown a wireframe flowchart diagram of some steps of a method 1700 for using the system 100. First, a user downloads 1702 the system 100 onto a computing device. Then, the user causes the system 100 to be executed 1704 on the computing device. Next, the system displays an option to watch a short tutorial video. Then, the user selects a template 1706 to begin collecting multi-media content 1708. Next, the user reviews and edits the multi-media content gathered and displayed on the page. The user can also save the data at any point in the collection process. Then, the system 100 stores a state of the finished page 1710 of multi-media content collection in case an event occurs to interrupt the system. For example, if the system is closed, or an incoming call is answered, the system 100 will automatically save the current state of the data so that the user can resume at the point the event occurred. Finally, after all the multi-media content is collected, the user can review, save, edit, change templates and finalize the multi-media content to be shared 1712 on various social channels, such as, for example, email, text, Dropbox®, or a camera roll. Finally, a confirmation 1714 is sent to the user.

Consumers and companies are time-crunched and are looking for ways to do more in less time. Both receive information in sound bites, or in limited capacities, with links to more content. The system delivers on that same concept, but used as a way to format all content in one location.

Other features contemplated by the system:
A centralized aggregator, or strategic partnership with an existing aggregator system, that supports consumer and business facing products. The aggregator holds all content per account and users with proper credentials can access the content to be used in other pages.
Ability to embed more photos in the page in an “album” or “more” container, for enhanced sharing/engagement and make them available for purchase.
Embed QR codes in the page for audio/video clips. If a page is printed as a scrapbook page or flyer for handout, the recipient can play back the embedded clips via a QR reader app on a mobile device.
A web based portal for drag and drop template creation. Any user can create and upload a template to a backend system for delivery into any of the app solutions. Login credentials identify them as public or private.
Flash or HTML5 animated photo containers for enhanced viewing.
Compilation and sale of analytics.
Moderator. Some users may need the page approved before it can be posted to public platforms. This can be addressed in two ways:
   a) The system has a module that identifies templates for a specific brand to be sent to an approval location (email address, cleansing software) prior to be shared to the intended location. The system returns a message to the user that the page is awaiting approval and will be shared momentarily.
   b) Cleansing software may be a 3rd party plug in that reviews the pages for unapproved words and sanitizes it before sharing or rejects it outright. If rejected a message is returned to the user who created it. The page and account information is returned to the subscribed user associated with the template; the subscribed user can determine what action to take (email warning, suspended account).
Video containers: The system uses the captured video and collects up to 3 still images at pre-programmed frame locations, and places those still images side by side in the video container on the finished page.
Utilizing blank browser space. When the finished page is shared there is unused space to the left and right of it, within the browser. This space can be used for ads and announcements of any kind that can be programmed into the system to accompany particular pages when they are shared.

What has been described is a new and improved system for a real-time mobile multi-media content management system for marketing, communication and engagement, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A real-time mobile multi-media content management and communications system for marketing and engagement, the system comprising:
a) a processor comprising a storage where the storage contains instructions executable on the processor for:
1) a multi-media user interface module;
2) a multi-media content collection module;
3) a multi-media templating module; and
4) a communications module;
where the modules provide a user with real-time multi-media content management to market and engage third parties.

2. The system of claim 1, where multi-media user interface module comprises instructions executable on a mobile processor to display a simple interface to the user to gather multi-media content from various content storages.

3. The system of claim 2, where the multi-media user interface module displays easy to identify icons to indicate the kind or type of content that would be gathered by the user.

4. The system of claim 2, where the multi-media user interface also comprises instructions to provide instructions to the user on how to operate the system.

5. The system of claim 1, where the multi-media content collection module comprises instructions executable on the processor to capture, organize and format multi-media content from multiple mobile software applications across multiple platforms.

6. The system of claim 1, further comprising instructions to build multi-media content in real-time, so that the user can quickly review, approve and edit the content as the system adds more content.

7. The system of claim 6, where the system also comprises instruction so the user can collect the multi-media content and build a marketing page on one screen without using any external programs.

8. The system of claim 1, where the multi-media content can be selected from the group consisting of photos, text, details, quotes, places, dates, titles, audio or video.

9. The system of claim 8, where the multi-media content is dynamically loaded into the user selected template.

10. The system of claim 9, where the multi-media content collection module comprises instructions executable on the processor to automatically determine the type of the selected multi-media content.

11. The system of claim 1, where the multi-media templating module comprises instructions executable on the processor to display one or more than one pre-designed template to automate placement of multi-media content objects.

12. The system of claim 11, where a user can create a composite page of audio, video, text, image and location data that can be shared with other users.

13. The system of claim 11, where the user can select a pre-designed template consisting of a memory page, a scrapbook page, a content-rich branded page to promote products, or an event announcement page.

14. The system of claim 13, where the pre-designed template comprises instructions executable on the mobile processor to populate the selected placeholder with multi-media content.

15. The system of claim 13, further comprising a credential module for accessing private templates that are not available to the public.

16. The system of claim 15, where the multi-media content collection module can arrange the multi-media content on the user selected template in a pre-determined arrangement based on the pre-designed template design.

17. The system of claim 16, where if the user declines to use all the available multi-media content options on the pre-designed template, the system automatically removes any supporting graphics from the finished page related to declined multi-media content.

18. The system of claim 17, where the system dynamically adjusts and reformats the finished page based on the size and type of the collected multi-media content.

19. The system of claim 18, where the system comprises instructions so that the user can review the multi-media content in a plurality of templates.

20. The system of claim 1, where the communication module comprises instructions executable on the processor so users can interact with social media in real-time to engage the user's friends.

21. The system of claim 20, where the finished page can be transmitted to one or more location selected from the group consisting of Facebook®, Twitter®, Tumblr®, DropBox®, email, a text message, a camera roll, Instagram®, or Pinterest®.

22. The system of claim 21, where the finished page is transmitted to the one or more than one location as a clickable link that enacts a browser window to open and display the finished page, properly reformatted.

23. The system of claim 1, further comprising a back-end server having instructions executable on a processor for backend analytics that can track user interaction with the system.

24. The system of claim 23, where the back-end server comprises:
a) a processor and a storage for storing data and instructions executable on the processor: and
b) a data mining module to perform analytics for tracking each click that occur on pages created and published by the system.

25. The system of claim 24, where the analytics tracked by the system are selected from the group consisting of templates used, templates purchased, template style, sharing location, a number of applications used by location, or a call-to-action clickthru.

26. The system of claim 1, further comprising a secured server that can host the multi-media content and pre-designed templates to be retrieved by the mobile device.

27. The system of claim 26, where the secured server can transfer the multi-media content to the finished page at each sharing location.

28. A method for using a real-time mobile multi-media content management and communications system for marketing and engagement, the method comprising the steps of:
a) downloading the system of claim 1 onto a computing device;
b) executing the system on the computing device;
c) displaying an option to watch a short tutorial video;
d) selecting “new page” to collect multi-media content from the computing device, a storage or both the computing device and the storage;
e) reviewing the collected multi-media content;
f) editing the collected multi-media content;
g) displaying the reviewed and edited collected multi-media content on the final page;
h) storing in a storage a state of the page of multi-media content collection in case an event occurs to interrupt the system; and
i) sharing the final page on social media channels after all the multi-media content is collected, reviewed, saved, edited, changed templates and finalized.

29. The method of claim 28, further comprising the step of saving the collected data and the page at any point in the collection process.

30. The method of claim 28, where the multi-media content can be collected from storage locations selected from the group consisting of email, text, Dropbox®, or a camera roll.
